(19) United States
(12) Patent Application Publication
(10) Pub. No.: US 2018/0293535 A1
(43) Pub. Date: Oct. 11, 2018

(54) RFID SYSTEM AND METHOD FOR TRACKING ASSETS

(71) Applicant: Strategic Data Systems, San Diego, CA (US)

(72) Inventor: James Christopher, La Mesa, CA (US)

(21) Appl. No.: 15/481,399

(22) Filed: Apr. 6, 2017

(51) Int. Cl. G06Q 10/08; G06K 19/07; G06K 7/10

(52) U.S. Cl. CPC G06Q 10/087; G06K 7/10316; G06K 19/0723

(57) ABSTRACT

Embodiments disclosed herein include system and methods for tracking assets. Such embodiments may include one or more passive radio frequency identification (“RFID”) asset tags programmed to store information identifying an asset tagged with a passive RFID asset tag and one or more passive RFID locations tags programmed to store information identifying placement location of a passive RFID location tag. In some instances, at least one reader may be included to emit a radio frequency signal in order to scan and receive information stored on the passive RFID location tag and passive RFID asset tag. Additionally, a server may receive and store information transmitted from the reader.

### TECHNICAL FIELD

The disclosed technology relates generally to radio-frequency identification (hereinafter “RFID”) technology. More specifically, the disclosed technology relates to RFID technology for locating and tracking assets.

### BACKGROUND

Warehousing and logistics operations often describe the loss of inventory due to misplacement, theft, or administrative errors known as “shrinkage.” According to warehouse industry sources, the annual cost for shrinkage is about 1.5% of the inventory. Additionally, shrinkage often results in a domino effect in the supply chain since this impacts not only in the loss of sales, but also in overall labor costs and efficiency when attempting to relocate and resolve the misplaced or missing inventory. This is especially true since warehouse and logistics operations can be particularly manually intensive, which further adds onto the added labor costs and inefficient work flow.

While traditional warehousing and logistic operations use barcode technology to manage and track down inventory, barcode technology has its drawbacks. For example, a user or person must manually hold or position the barcode label close enough and in such a way that will allow the scanner to properly read the barcode label. Additionally, barcode technology cannot track or locate the assets in a warehouse. Barcode technology has no means for locating misplaced or lost assets in a warehouse. Instead, warehouse employees must manually search the warehouse aisle-by-aisle and item-by-item to locate misplaced assets. This is time consuming, labor intensive, and costly. As a result there is a need for a more efficient system and method for tracking and locating objects and items (also referred to herein as “assets”) in a warehouse or building.

### BRIEF SUMMARY OF EMBODIMENTS

According to various embodiments of the disclosed technology, disclosed is a system for tracking an asset. Such a system, by way of example only, may include one or more RFID asset tags programmed to store information identifying an asset tagged with a RFID asset tag; one or more RFID location tags programmed to store information identifying placement location of a RFID location tag; at least one RFID reader that emits a radio frequency signal to scan and receive information stored on the RFID location tag and RFID asset tag; and a server that receives and stores information transmitted from the RFID reader to a database.

Also disclosed herein is a method for tracking an asset. Some embodiments may include placing one or more RFID asset tags on an asset to be monitored; placing one or more RFID location tags in locations that store the asset; emitting a RF signal from a RFID reader to scan a RFID asset tag and a RFID location tag; and transmitting information stored on the RFID asset tag and the RFID location tag to the RFID reader; and the RFID reader transmitting the information to a server and a database.

Other features and aspects of the invention will become apparent from the following detailed description, taken in conjunction with the accompanying drawings, which illustrate, by way of example, the features in accordance with embodiments of the invention. As such, the summary is not intended to limit the scope of the invention.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a RFID system 100 according to one embodiment of the present invention.

FIG. 2 illustrates an exemplary embodiment in which the RFID system may be implemented according to one embodiment of the present invention.

FIG. 3 illustrates an exemplary embodiment in which asset data and location data may be implemented according to one embodiment of the present invention.

FIG. 4 illustrates an exemplary embodiment in which RFID location tags are used to create a digital map according to one embodiment of the present invention.

FIG. 5A illustrates the tracking of assets according to one embodiment of the present invention.

FIG. 5B illustrates the tracking of assets according to one embodiment of the invention.

FIG. 5C illustrates the tracking of assets according to one embodiment of the present invention.

FIG. 6A illustrates the tracking of assets according to one embodiment of the present invention.

FIG. 6B illustrates the tracking of assets according to one embodiment of the present invention.

FIG. 6C illustrates the tracking of assets according to one embodiment of the present invention.

FIG. 6D illustrates the tracking of assets according to one embodiment of the present invention.

FIG. 7 is a flow chart for operating a RFID system to locate and track assets and items with a RFID asset tag and a RFID location tag according to one embodiment of the present invention.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

The following description is not to be taken in a limiting sense, but is made merely for the purpose of describing the general principles of the disclosed embodiments. The present embodiments address the problems described in the background while also addressing other additional problems as will be seen from the following detailed description. Numerous specific details are set forth to provide a full understanding of various aspects of the subject disclosure. It will be apparent, however, to one ordinarily skilled in the art that various aspects of the subject disclosure may be practiced without some of these specific details. In other instances, well-known structures and techniques have not been shown in detail to avoid unnecessarily obscuring the subject disclosure.

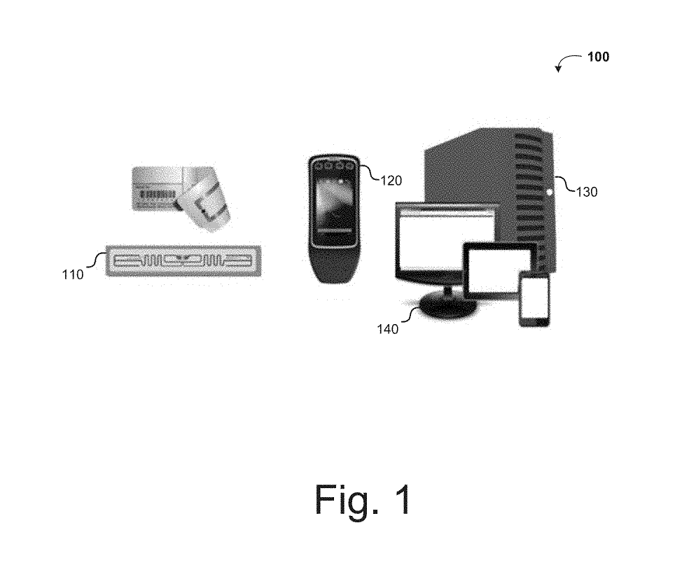

FIG. 1 illustrates an exemplary embodiment of a RFID system 100 according to one embodiment of the present invention. A RFID system 100 may contain a RFID tag 110, a RFID reader 120 or otherwise referred to as a “reader”, and a computer server 130 in connection with one or more computer devices 140. The RFID tags 110 may be small strips of paper or plastic containing a chip and an antenna. The RFID tags 110 may even be programmed with digital data. In some embodiments, by way of example only, a barcode may even be printed on the RFID tag 110.

Additionally, the reader 120 may be a receiver and a transmitter. The reader 120 may be a hand-held model and may even be installed on forklifts, vehicles or other various objects. In other embodiments, the reader 120 may be a fixed reader located at a doorway, loading dock, or chokepoint. The reader 120 may emit a lower power radio frequency (“RF”) signal so that when the RFID tag 110 is within close proximity or within range of the reader 120, the information is automatically transmitted from the RFID tag 110 to the reader 120.

By way of example, the RFID tag 110 may be a passive tag or an active tag. In some instances, by way of example only, the RFID tag 110 may have no internal power source and instead, is powered by the electromagnetic energy transmitted by the reader 120. The information contained within the RFID tag 110 may be transmitted to the reader 120 upon the scanning of the RFID tag 110. This allows the RFID tag 110 to have a long shelf life without having to worry about the batteries. However, it should be noted that the RFID tag 110 can also be configured to be an active tag, where such a RFID tag 110 will contain its own internal batteries to power its circuits. In this case, the active RFID tag 110 will use its own battery to transmit and broadcast its own waves to the reader 120. In this particular instance, the active RFID tag 110 will continuously broadcast its own signal regardless of whether or not a reader is close-by.

While traditional applications of a RFID system 100 typically place the RFID tags 110 on objects or assets and the readers 120 located at stationary control points, this requires that the objects or assets tagged with the RFID tags 110 to be transported past the stationary readers 120 in order for the RFID tags 110 to be scanned. In stark contrast, by way of example only, the disclosed RFID system 100 may differ from such conventional systems by having the opposite set-up: the RFID tags 110 are stationary while the readers 120 move around the facility to scan the RFID tags 110. The reader 120 may then scan and transmit the information stored in the RFID tags 110 to a server 130 and a database, where the scanned RFID tag data may then be displayed onto computing devices 140. In this manner, based on the data from the transmitted information stored in the RFID tags 110 to the sever 130 and database, the RFID system 100 may provide a means for users to monitor the location of any object or asset that is fitted with RFID tags 110. More information detailing the monitoring of assets with the use of the RFID system 100 is presented in further detail below.

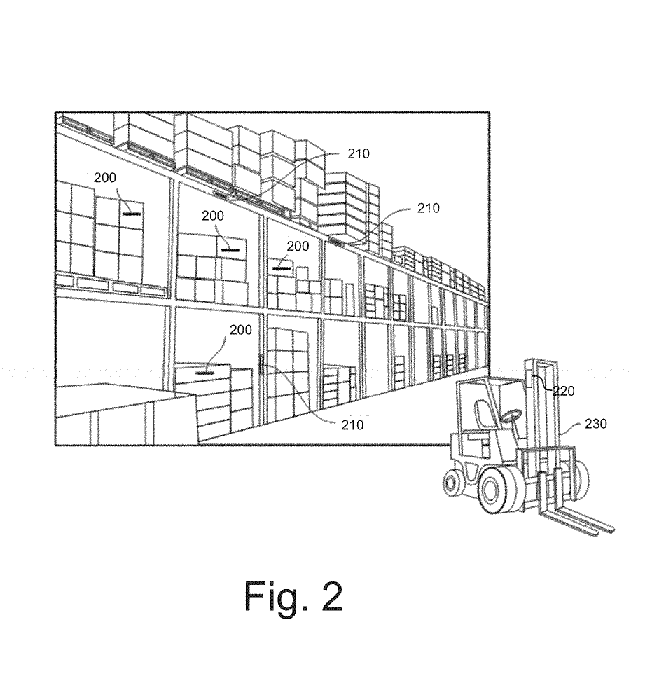

FIG. 2 illustrates an exemplary embodiment in which RFID tags may be implemented according to one embodiment of the present invention. As illustrated, RFID asset tags 200 are affixed to assets (e.g., parts or any inventory item). These RFID asset tags 200 may be programmed so that each RFID asset tag 200 is associated with a unique identifier. The unique identifier may then allow for the distinguishing of each asset from one another.

In other embodiments, the RFID asset tags 200 may be programmed to store specific information identifying the assets tagged with that particular RFID asset tag 200. Such information may include specific handling instructions or delivery requirements that may be useful to know when transporting or handling that particular asset. When the RFID asset tags 200 are scanned by a reader 220, the data from the RFID asset tags 200 may then be transmitted to the reader 220, which may then be transmitted to a database and displayed onto a computing device for a user to view.

In some embodiments, RFID location tags 210 may be configured to provide its precise location detail within a warehouse by storing its location information. By way of example, the location RFID location tags 210 may be placed on shelve aisles, shelve rows, warehouse shelves, columns, walls, floors, choke points, pathways for personnel or vehicles, or any other areas within a warehouse. When the RFID location tag 210 is scanned by a reader 220, the stored location information, which may be in the form of a unique identifier, is then transmitted to the reader 220.

In some embodiments, a reader 220 may be affixed to objects that move throughout the warehouse or facility frequently, so as to allow for the frequent updates of an asset's location via the scanning of the RFID asset tags 200 and RFID location tags 210 by a reader 220, and then transmitting the data to the server and database. By way of example, the reader 220 may be affixed to forklifts 230 since they frequently travel around assets. Other exemplary objects that the reader may be affixed onto, by way of example, may include personnel lifts, carts, or workers themselves. In some instances, a plurality of readers 220 may be attached onto a plurality of various moving objects so as to ensure that the RFID asset tags 200 and RFID location tags 210 are frequently monitored.

As the readers 220 move through the warehouse or facility, the readers 220 may scan both the RFID asset tags 200 and the RFID location tags 210. Additional information may also be obtained from the scanning of the RFID asset tags 200 and the RFID location tags 210, such as the date and time in which the tags were scanned. All of the scanned information from the reader 220 may then be transmitted to a database so that a computing program may analyze the data to determine asset location.

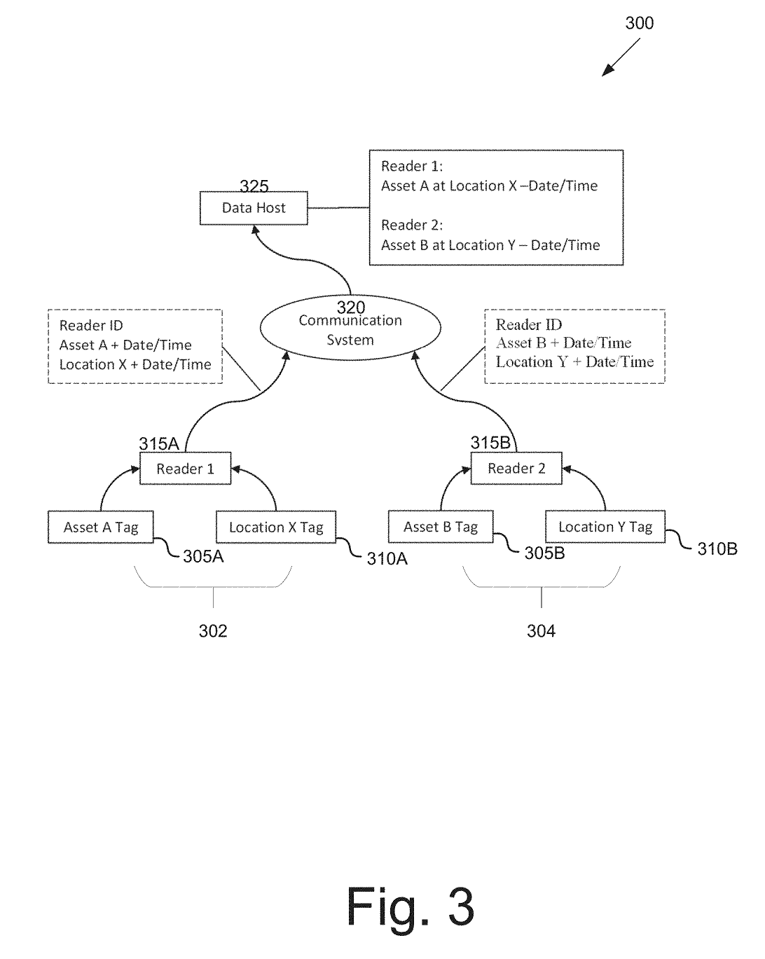

FIG. 3 illustrates an exemplary embodiment in which asset data and location data may be implemented according to one embodiment of the present invention. Here, the RFID system 300 includes two sets of RFID tags by way of example, so that first RFID tag set 302 may include RFID asset tags 305A and RFID location tags 310A. Additionally, the second RFID tag set 304 may include its own set of RFID asset tags 305B and RFID location tags 310B. However, it should be noted that there may be any number of RFID tag sets as well as multiple RFID asset tags for a single RFID location tag.

The first RFID tag set 302 may correspond to its own reader 315A and the second RFID tag 304 may also correspond to its own reader 315B as well. In other instances, the same reader may be used to scan both the first RFID tag set 302 and the second RFID tag set 304.

When the first reader 315A and the second reader 315B scans the corresponding RFID tag set 302 and 304, the information stored on the RFID tag set 302, 304 may be transmitted to a data host 325 via a wireless network 320. The received information may include information about the readers 315A and 315B as well as the location and asset tag information. Other information may also include the date and time of the scanning of the RFID tag sets 302 and 304 from its corresponding readers 315A, 315B.

The date and time information may then be used to calculate the dwell time of the assets. Dwell time might be important additional generated information that allows a user to determine the duration of time in which an asset is at any location. In other words, dwell time can be used as a valuable metric for assessing the flow of the assets around the warehouse or storage area, such as efficiency in the transporting of the assets around the warehouse. Additionally, this allows a user to determine the turnaround time of inventory, which may even help the user to determine whether more or less inventory is needed.

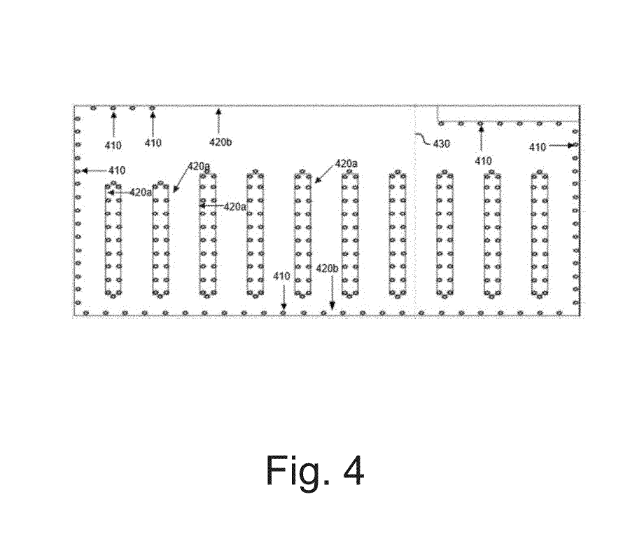

FIG. 4 illustrates an exemplary embodiment in which location tags are used to create a digital map according to one embodiment of the present invention. Here each of the RFID location tags 410 are affixed to various areas that store assets, such as warehouse shelves 420a or walls 420b, columns, floors, choke points, and pathways. By placing the RFID location tags 410 throughout the warehouse or throughout the areas that store the assets, the RFID location tags 410 may be used to create a digital map of the warehouse or logistics enterprise. Additionally, the system may allow users to define rules that specify particular areas where particular assets may or may not be located or stored. In other words, the RFID location tags 410 may provide a way for users to digitally identify areas for collocating or separating assets of certain types using user identified rules or criteria. This may also be referred to as geo-fencing.

By way of example only, the user may create rules that place geo-fence 430 around a select area so that only a select group of assets are permitted within that area. Any assets that do not meet such a criteria must be located outside of the geo-fence 430. If a RFID asset tag is moved into an area the violates those user defined rules of the geo-fence 430, an alarm will be issued to notify the user. By way of example only, the reader may scan the RFID location tag 410 and an asset with a RFID asset tag (not shown here) and transmit the information to the server and the database, and if the asset is in violation of the user defined rules, a program on a computing device may be configured to generate an alarm to alert a user.

The geo-fence 430 feature may also provide an added safety pre-caution measure to alert users when objects are placed in close proximity with one another that violate user-defined rules. Additionally, this may help ensure that assets are properly stored and transported within the warehouse or logistics enterprise.

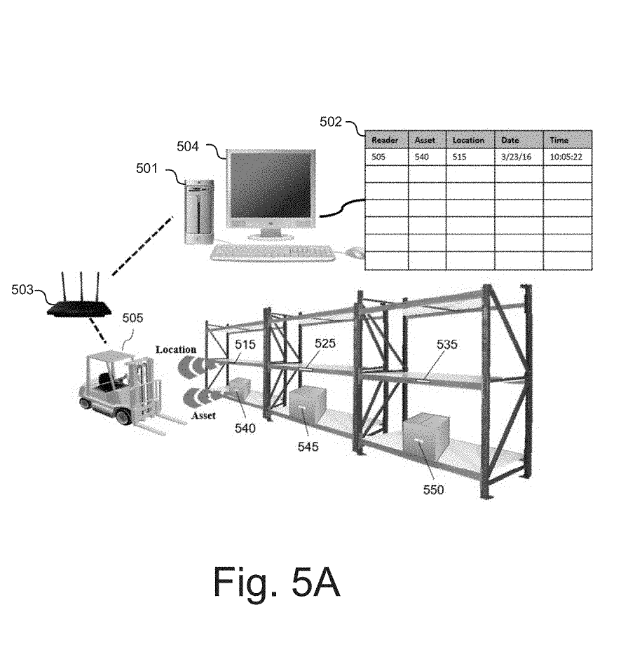

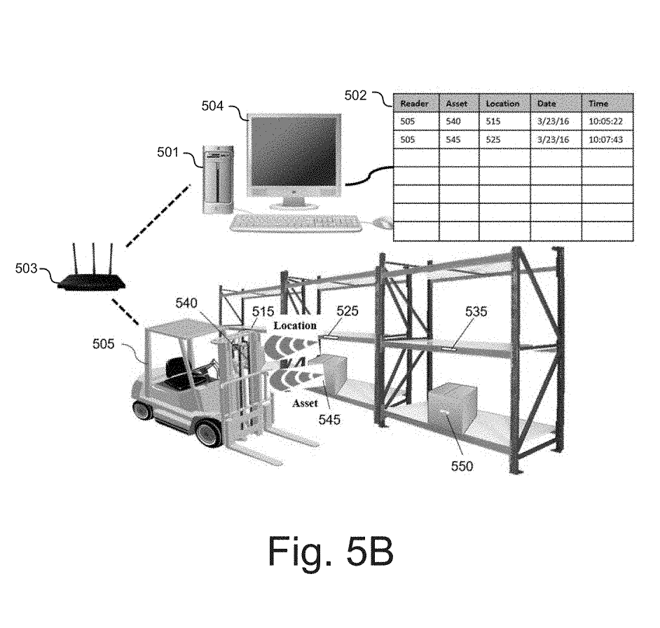

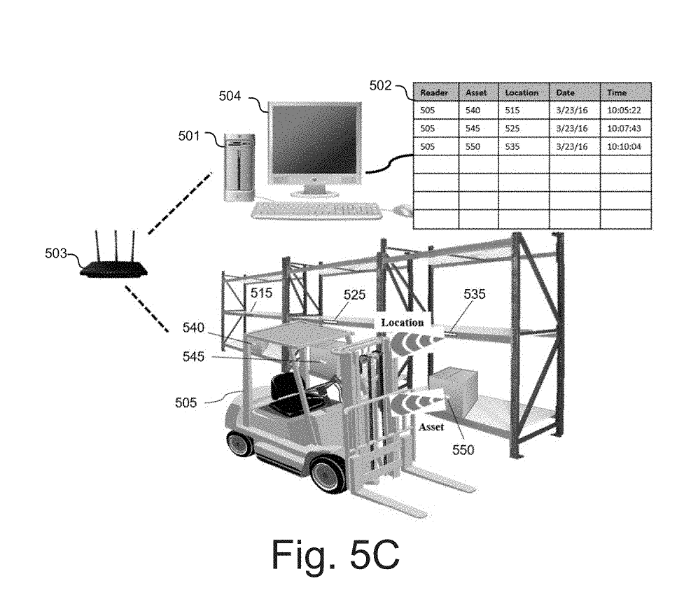

FIGS. 5A, 5B, and 5C illustrate the tracking and location of assets automatically according to one embodiment of the present invention. As a result, FIGS. 5A, 5B, and 5C will be described herein together. As illustrated in FIGS. 5A-5C, a reader is attached to a forklift 505, which is able to scan RFID tags as the forklift 505 passes by them. Here, the RFID tags may include RFID location tags 515, 525, 535 and RFID asset tags 540, 545, 550. The RFID location tags 515, 525, 535 may be placed at each shelf or designated area where the assets are stored. The RFID asset tags 540, 545, 550 may be affixed onto the assets. In order to provide a user with the most precise location and item description of an asset, the RFID location tags 515, 525, 535 and the RFID asset tags 540, 545, 550 may store detailed information or each contain a unique identifier that allows a processor or a user to identify the location and asset associated with each of the RFID tags.

As illustrated in FIG. 5A, as the forklift 505 with a reader is passing by a first asset with a RFID asset tag 540, the reader scans RFID asset tag 540 in conjunction with the RFID location tag 515, and the RFID tag data is then transmitted to a server and database via a network communication system 503. The scanned RFID asset tag data and RFID location tag data is stored in the database. Additionally, the reader may also transmit additional information, such as the date and time in which the RFID tags were scanned. A computing program 501 may then obtain the scanned RFID asset tag data and RFID location tag data from the database to then determine the precise and exact location of the asset associated with its corresponding RFID asset tag 540 and RFID location tag 515 information.

Furthermore, the computing program 501 may present the information in a graph and tabular format 502, which allows a user to quickly identify exactly where the assets are located based on the date and time of the scanning. Here, as illustrated in FIG. 5A, a user is able to view on a computing device 504 that the particular asset associated with RFID asset tag 540 is located at an area tagged with RFID location tag 515 as of Mar. 23, 2016 at 10:05:22 A.M., which was scanned by reader identified as 505. Such availability of data may be accessible to the user in real time or near real time of the scanning of the RFID location tags 515, 525, 535 and the RFID asset tags 540, 545, 550.

As further illustrated in FIG. 5B, as the forklift 505 with the reader passes by another RFID asset tag 545, the reader on the forklift 505 scans RFID asset tag 545 and RFID location tag 525, and both RFID tag data is transmitted to the server and database via a network communication system 503. The data associated with the RFID asset tag 545 and the RFID location tag 525 is then stored on the database immediately upon the scanning of the tags. Again, the data associated with these tags may include the date and time in which they were scanned by the reader, thus allowing the determination of the precise location of the asset. Such data may be displayed in a graph and tabular format 502 on a computing device 504, which may include all the necessary information for a user to locate or monitor the asset. The same occurs for the next asset illustrated in FIG. 5C, where the forklift 505 reader scans RFID asset tag 550 and RFID location tag 535, and the RFID tag data is transmitted to the server and database via a network communication system 503, where RFID asset tag 550 is associated with RFID location tag 535 when determining the location of that particular asset associated with those RFID tags. All of the transmitted data from the reader may be stored onto the database and viewed in a graph or tabular format 502 on a computing device 504.

Additionally, the transmission of the RFID tag data to the communication system 503 and into the server and database may be simultaneous or near instantaneous with the scanning of the tags. Thus, the data stored and presented in the database may be in real time, or substantially in real time.

Additionally, the RFID system can be extended from indoor to outdoor location with the integration of global positioning system (GPS) technology. This may allow users to locate the assets when transported out of the warehouse using a standard mapping services, such as Google Maps on a PC, tablet or smartphone.

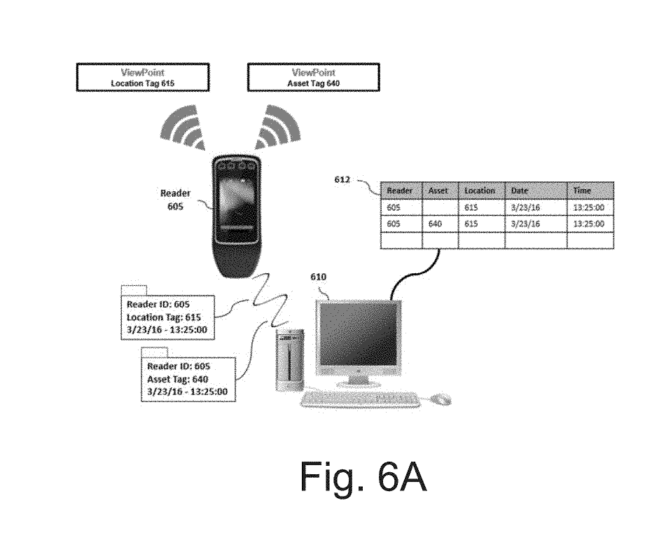

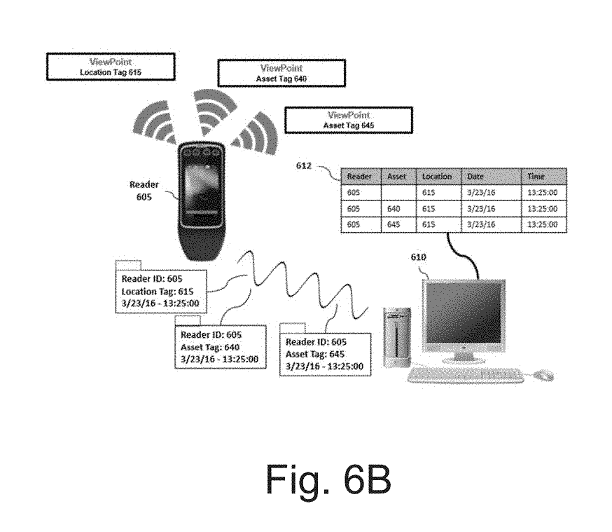

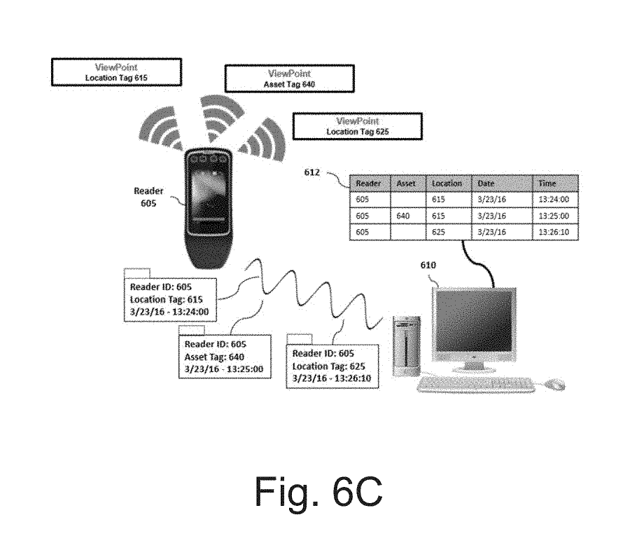

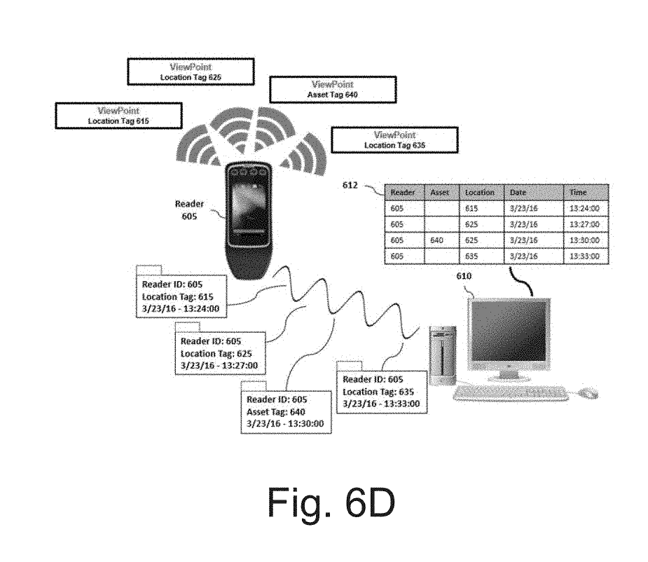

FIGS. 6A-6D illustrates the tracking of inventory according to various embodiment of the present invention. As illustrated, FIG. 6A depicts a reader 605 scanning both a RFID location tag 615 and a RFID asset tag 640. The scanned data associated with the respective tags are then transmitted to a server and a database, where such data information can then be accessed with a computer device 610. Upon the scanning of the RFID location tag 615 and the RFID asset tag 640, the date and time in which the tags were scanned may also be transferred to the server and database. In some embodiments, the identification of the scanner that performed the scanning may also be transmitted to the server and database. The database may then process the received data to identify the precise location of the asset by associating the RFID location tag 615 with the RFID asset tag 640.

One way of associating the RFID asset tag 640 to the correct RFID location tag 615 is by establishing a set time frame, or time tolerance, in which the RFID location tags and the RFID asset tags must both be scanned. Thus, selecting the RFID location tag that matches most closely with a scanned time of the RFID asset tag indicates that the RFID location tag is the correct tag identifying the asset's location. By having a set time frame, or time tolerance, this ensures that no single asset is associated with more than one RFID location tag, and rather, associating one RFID location tag that will convey the most accurate location information.

As illustrated in FIG. 6A, a reader 605 scanned an asset with RFID asset tag 640 at 13:25:00 as well as and RFID location tag also at 13:25:00. Because both of these RFID tags have the same time data, the database and a computing program will identify that these two tags must be associated together to reveal the asset's location. The data and information may then be presented in viewable format 612 on a computer device 610 for the user's viewing option. Here, a user will be able identify and confirm that a reader 605 scanned an asset with RFID asset tag 640 on Mar. 23, 2016 at 13:25:00, and that the asset is located in the area corresponding to RFID location tag 615.

FIG. 6B illustrates a different scenario where a reader 605 scans RFID location tag 615 and multiple RFID asset tags 640, 645 simultaneously. As depicted, the scanning of the RFID location tag 615 and RFID asset tags 640, 645 all occur at 13:25:00. The scanned data, as well as the time and data information, is then transmitted to the server and database, where the database processes the data to determine the location of the asset associated with RFID asset tags 640, 645. Because in this particular example, all of the tags were scanned simultaneously, and so the RFID asset tags 604, 645 are each associated with the RFID location tag 615 when determining the location of the asset. Again, this information and data may be presented in tabular form 612 on a computing device 610 for viewing purposes.

FIG. 6C illustrates another scenario where a reader 605 scans RFID asset tag 640 along with two different RFID location tags 615, 625. The scanned data is then transmitted to the server and database, where the database and computing program may then determine which of the RFID location tags 615, 625 will correspond to the RFID asset tag 640, so that the asset associated with the RFID asset tag 640 is only assigned one location. To determine which of the RFID location 615, 625 is associated with the RFID asset tag 640, the computing program may identify the RFID location tag that has the closest scan time to the scanning of the RFID asset tag 640. Here, the RFID asset tag was scanned at 13:25:00 while the RFID location tag 615 was scanned at 13:24:00 and the other RFID location tag 625 was scanned at 13:26:10. Because RFID location tag 615 was scanned at a time that is closest to the scanning of the RFID asset tag 640, the computing program will associate the RFID location 615 with the RFID asset tag 640 when determining the location of the asset associated with RFID asset tag 640. This information will then be stored and presented in tabular format 612 on a computer device 610, so that the user may view and monitor this information.

FIG. 6D illustrates another scenario where the reader 605 scans a RFID asset tag 640 and multiple RFID location tags 615, 625, 635 within relative close proximity in time. These scanned data, as well as the time and date scanned, may then be transmitted to the server and database, where the database processes the data to determine the location of the asset. Again, a computing program may then determine which of the RFID location tags 615, 625, 635 will correspond to the RFID asset tag 640, so that the asset associated with the RFID asset tag 640 is only assigned one location. To determine which one of the RFID location tags 615, 625, 635 is associated with the RFID asset tag 640, the computing program will look at each of the scanned times associated with each of the RFID location tags 615, 625, 635. The RFID location tag with the closest scan time to the scan time of the RFID asset tag 640 will then be determined to be the correct RFID location tag associated with the RFID asset tag. Here, the RFID asset tag was scanned at 13:30:00, while one RFID location tag 615 was scanned at 13:24:00 and the other RFID location tag 625 was scanned at 13:27:00 and the other RFID location tag 635 scanned at 13:33:00. Because the RFID location tags 625 and 635 were scanned at a time closest to the scanning of the RFID asset tag 640, the computing program may then utilize other factors to determine how to associate RFID asset tag 640 with the RFID location 625 This information will then be stored and presented in tabular format 612 on a computer device 610 so that the user may view and monitor this information continuously. When time alone cannot clearly determine location, additional factors may be utilized. For example, user based rules may be implemented to associate the correct RFID location tags to the corresponding RFID asset tags.

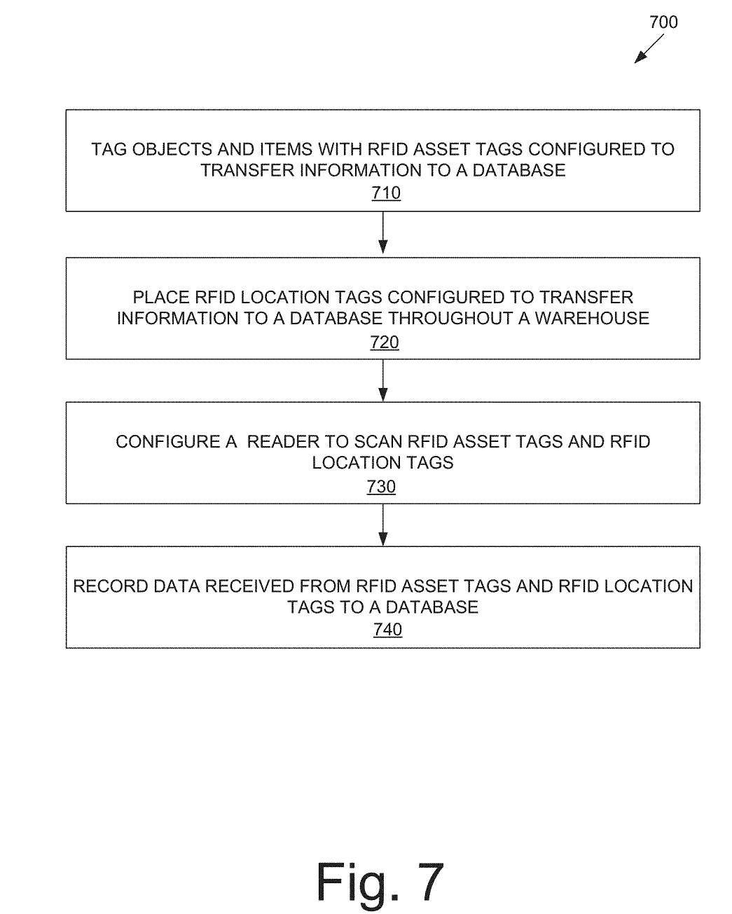

FIG. 7 is a flow chart for operating a RFID system to locate and track assets and items with a RFID asset tag and a RFID location tag according to one embodiment of the present invention. By way of example, one exemplary method 700 includes tagging assets and items in a warehouse with a RFID asset tag at step 710. Additionally, the RFID asset tag may each be encoded with specific data about the particular object or item, such as the item number or other information about the item. In other instances, the RFID asset tag may include a unique identifier so as to identify and distinguish amongst the other RFID asset tags.

Next, the method 700 may proceed onto step 720, where RFID location tags are placed throughout a warehouse and each tag is encoded with the precise location of that tag within the warehouse. The RFID location tags may be placed in any areas of the warehouse including shelves, walls, columns, floors, choke points, and pathways.

Next, at step 730, readers are placed on entities that frequently transit throughout the warehouse. Readers may then scan RFID asset tags and RFID location tags.

Next, the method 700 may proceed to step 740, where the scanned information from the RFID asset and location tag are transmitted to the database. In some instances, the reader identification data and the date and time of the scanning may also be transmitted to the server and database. Once the data is processed and stored in the database, a user may be able to view or access information with a computer device. In some instances, the data may be configured into graphical and tabular format so that the user may be able to quickly assess and view the information.

In some instances, the database computes and provides asset locations, asset dwell times, reader dwell times, reader travel histograms as well as other metrics required by warehouse personnel, users, and managers.

Various embodiments have been described with reference to specific example features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various example embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the present application, whether or not such embodiments are described and whether or not such features are presented as being a part of a described embodiment. Thus, the breadth and scope of the present application should not be limited by any of the above-described example embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide illustrative instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent.

Additionally, the various embodiments set forth herein are described in terms of example block diagrams, flow charts, and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

What is claimed is:

1. A system for tracking an item comprising:
one or more passive radio frequency identification (“RFID”) asset tags encoded with information identifying the item tagged with a passive RFID asset tag;
one or more passive RFID locations tags encoded with information identifying placement location of a passive RFID location tag;
at least one reader that emits a radio frequency signal to scan and receive data stored on the passive RFID location tag and passive RFID asset tag; and
a server that receives and stores data transmitted from the reader to a database;
wherein the database stores the transmitted data of the passive RFID location tag and the RFID asset tag to determine a location of the item.

2. The system of claim 1, wherein the reader is placed on at least one of a person, forklift, personnel lift, and cart operating within a warehouse or other facility or building.

3. The system of claim 1, wherein the passive RFID location tag is placed throughout an area to create a digital map of the enclosed area.

4. The system of claim 1, wherein the reader transmits a first time stamp data corresponding to a scanning of the RFID location tag and a second time stamp data corresponding to a scanning of the RFID asset tag to a server and a database.

5. The system of claim 4, wherein the database is configured to implement a user defined time rule so that a scanned RFID location tag is associated with a corresponding scanned RFID asset tag to determine location of an item when the first time stamp data and the second time stamp data are both scanned within a set time frame.

6. The system of claim 4, wherein the database uses a first time stamp data and the second time stamp data to calculate a dwell time of the item.

7. The system of claim 4, wherein the reader further transmits its identification information to the server and the database each time the reader transmits data to the server and database.

8. The system of claim 1, wherein the passive RFID location tags are affixed to at least one of walls, shelves, rows, columns, floors, doorways, choke points, and pathways.

9. A method for tracking an item comprising:
placing one or more passive RFID asset tags on items to be located and tracked;
placing one or more passive RFID location tags in locations that store the items;
emitting an interrogation signal from a reader to scan the passive RFID asset tags and the passive RFID location tags; and
transmitting information stored on the passive RFID asset tags and the passive RFID location tags from the reader to a server and a database;
wherein the database processes information stored on the passive RFID location tag and the RFID asset tag to determine a location of the item based on time and date of the scanning of the passive RFID asset tags and the passive RFID location tags.

10. The method of claim 9, wherein the passive RFID asset tags are programmed to store information identifying the item that is tagged.

11. The method of claim 10, wherein the passive RFID location tag is programmed to store location information to identify a location of the item stored in that area.

12. The method of claim 10, wherein the scanning of each passive RFID asset tags comprises an asset tag time stamp code and the scanning of each passive RFID location tags comprises a location time stamp code.

13. The method of claim 12, wherein the database is configured to implement a user-defined time rule so that a scanned RFID asset tag is associated with a corresponding scanned RFID location tag to determine location of an item when the first time stamp data and the second time stamp data are both scanned within a specified time frame.

14. The method of claim 13, wherein the database is configured to implement another user-defined rule not associated with time stamp data when the first time stamp data and the second time stamp data are not within a specified time frame.

15. The method of claim 12, further comprising providing continuous location and tracking of the item in tabular or graphical representations on a computing device based on information transmitted from the passive RFID asset tag, passive RFID location tag, and date and time stamp transmitted from the reader.

16. The method of claim 10, further comprising creating a set of user based rules to establish boundaries determining areas where the item may enter and areas where the item is prohibited from entering.

17. The method of claim 16, further comprising sending an alert to a computer device when the item is in violation of any one of the set of user based rules.

18. A method for tracking an item comprising:
placing passive RFID asset tags on an item to be monitored;
placing passive RFID location tags in locations that store the item; and
scanning passive RFID asset tags and passive RFID location tags from a reader to collect and transmit information stored on the passive RFID asset tag and passive RFID location tag to a server and a database;
wherein the scanning of the passive RFID asset tags comprises an asset tag time stamp code and the scanning of passive RFID location tags comprises an location time stamp code to determine a location of the item.

19. The method of claim 18, further comprising generating an alert to notify a user when the reader scans the passive RFID location tags and passive RFID asset tags in violation of any of the set of predetermined rules.

20. The method of claim 18, wherein the database is configured to implement a user defined time rule so that a scanned RFID location tag is associated with a corresponding scanned RFID asset tag to determine location of an item when the asset tag time stamp code and the location time stamp code are both scanned within a specified time frame.
